(19) United States
(12) Patent Application Publication
(10) Pub. No.: US 2018/0294129 A1
(43) Pub. Date: Oct. 11, 2018

(54) FUSE BOX

(71) Applicant: GLORYTECH TECHNOLOGY CO., LTD., TAOYUAN CITY (TW)

(72) Inventor: HUAN-YAO KU, TAOYUAN CITY (TW)

(21) Appl. No.: 15/480,395

(22) Filed: Apr. 6, 2017

(51) Int. Cl. H01H 85/20

(52) U.S. Cl. CPC H01H 85/2015; H01H 2231/026

(57) ABSTRACT

The fuse box may accommodate at least two fuses, and includes a casing having a first face, a second face, and a third face; a first fuse socket and at least a second fuse socket configured on the first face, where each first and second fuse socket has a first fuse slot and a second fuse slot; a power plug configured on the second face, and electrically connected to the first fuse socket; at least a load cable connected to the third face, where the load cable includes a positive wire and a load wire electrically connecting the first and second fuse slots of the second fuse socket, respectively. The first and second fuse sockets are for the detachable installation of the fuses. As such, two or more fuses may be configured on a single casing to achieve more thorough protection to multiple car appliances.

### BACKGROUND OF THE INVENTION

### (a) Technical Field of the Invention

The present invention generally relates to fuse boxes and, more particularly, to a fuse box accommodating at least two fuses for protection of electronic apparatuses of a motor vehicle.

### (b) Description of the Prior Art

A fuse is a safety device that provides overcurrent protection of an electrical circuit. When too much current flows through it, the fuse interrupts the flow of current.

Fuses for motor vehicles include high current fuses and low current fuses. For low current fuses, there are blade type fuses, Bosch type fuse, glass tube type fuses, etc. Blade type fuses may sustain low current or impulse current and appropriate for headlight circuit, rear window defroster circuit, etc. The filament inside a blade type fuse is usually made of a metallic material similar to solder and has a melting point lower than normal conductive wires. The filament dimension has to be accurately calibrated so that it will be melted down to interrupt current flow at a rating current level.

As more and more electrical appliances are equipped on a motor vehicle, more fuses have to be installed in a more limited space so as to protect these electrical appliances.

### SUMMARY OF THE INVENTION

Therefore a major objective of the present invention is to provide a novel fuse box so that two or more fuses may be configured on a single casing to achieve more thorough protection to multiple car appliances.

To achieve the objective, the fuse box may accommodate at least two fuses, and includes a casing having a first face, a second face, and a third face; a first fuse socket and at least a second fuse socket configured on the first face, where each first and second fuse socket has a first fuse slot and a second fuse slot; a power plug configured on the second face, and electrically connected to the first fuse socket; at least a load cable connected to the third face, where the load cable includes a positive wire and a load wire electrically connecting the first and second fuse slots of the second fuse socket, respectively. The first and second fuse sockets are for the detachable installation of the fuses.

In one embodiment, the first and second faces are perpendicular to each other. The power plug is extended perpendicularly outward from the second face. The third face borders the first and second faces.

In one embodiment, the first and second faces are parallel to each other. The power plug is extended perpendicularly outward from the second face. The third face borders the first and second faces.

Each fuse includes a first fuse prong and a second fuse prong.

The first fuse prong is a positive terminal, and the second fuse prong is a negative terminal.

The power plug includes a first power prong and a second power prong.

The first power prong is a positive terminal, and the second power prong is a negative terminal.

The load cable electrically connects a car appliance.

The car appliance is one of an air conditioner, an event data recorder, a satellite navigation system, a cigarette lighter, a car stereo system, and a tire-pressure monitoring system.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings, identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram of a fuse box according to a first embodiment of the present invention.

FIG. 2 is a perspective diagram showing that a number of fuses to be plugged into the fuse box of FIG. 1.

FIG. 3 is a perspective diagram of a fuse box according to a second embodiment of the present invention.

FIG. 4 is a perspective diagram showing that a number of fuses to be plugged into the fuse box of FIG. 3.

FIG. 5 is a perspective diagram of a fuse box according to a third embodiment of the present invention.

FIG. 6 is a perspective diagram showing that a number of fuses to be plugged into the fuse box of FIG. 5.

FIG. 7 is a perspective diagram of a fuse box according to a fourth embodiment of the present invention.

FIG. 8 is a perspective diagram showing that a number of fuses to be plugged into the fuse box of FIG. 7.

FIG. 9 is a schematic diagram showing the fuse box of FIG. 7 connected to a number of car appliances.

### DETAILED DESCRIPTION OF THE PREFERRED EMBODIMENTS

The following descriptions are exemplary embodiments only and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

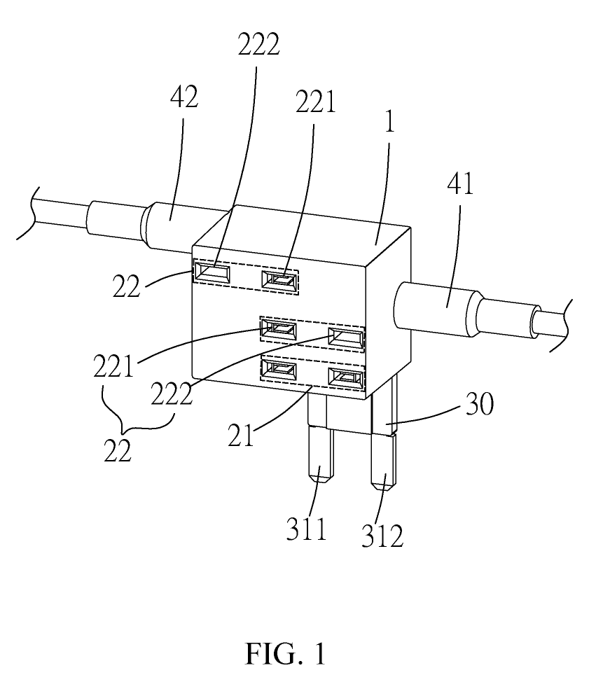

As shown in FIGS. 1 to 9, the fuse box according to the present invention accommodates at least two fuses 100. The fuse box includes a casing 1 having a first face, a second face, and a third face. A first fuse socket 21 and at least a second fuse socket 22 are configured on the first face. The first and second fuse sockets 21 and 22 are for the detachable installation of the fuses 100. A power plug 30 is configured on the second face and is electrically connected to the first fuse socket 21 (so that it is protected by the fuse 100 plugged into the first fuse socket 21). The second fuse socket 22 includes a first fuse slot 221 and a second fuse slot 222 (the first fuse socket 21 is similar and the description is omitted). At least a load cable 41 is connected to the third face and includes a positive wire (not shown) electrically connecting the first fuse slot 221 and a load wire (not shown) electrically connecting the second fuse slot 222.

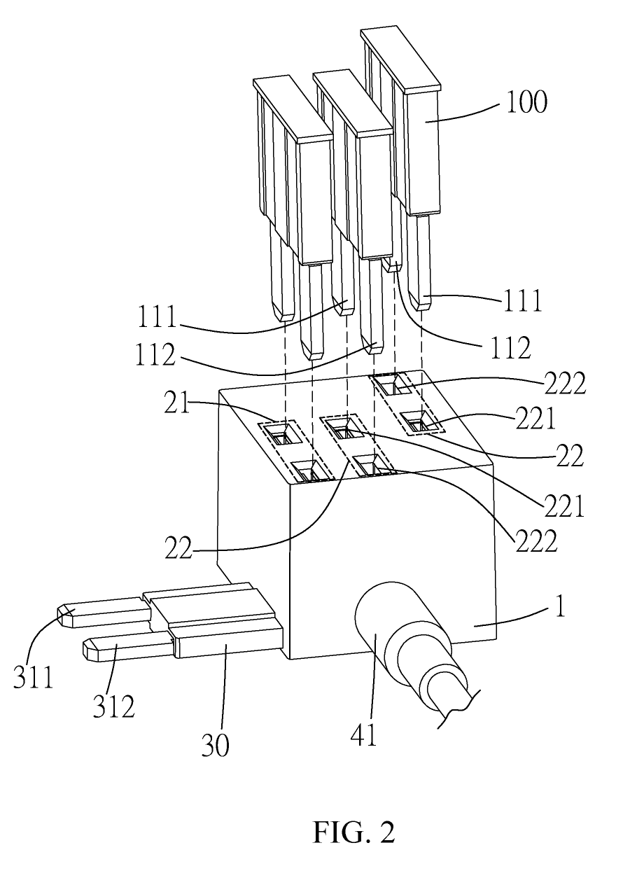

As shown in FIGS. 1 and 2, the casing 1 of a fuse box according to a first embodiment of the present invention has perpendicular first and second faces. The power plug 30 is extended perpendicularly outward from the second face.

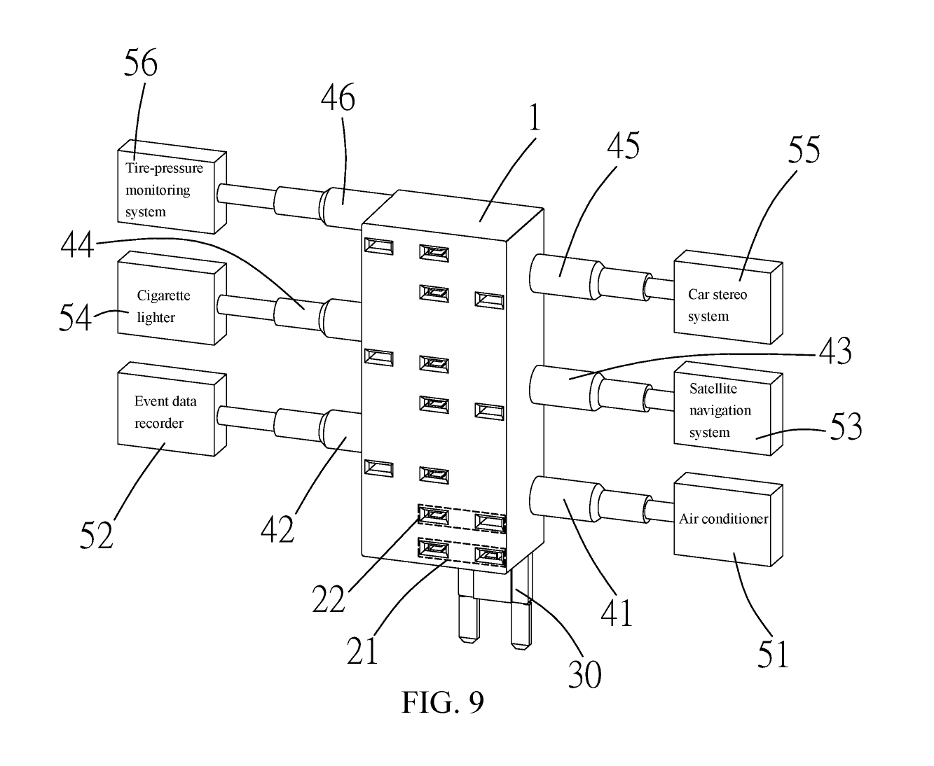

The third face borders on the first and second faces. As shown in FIG. 2, each fuse 100 includes a first fuse prong 111 and a second fuse prong 112. Each fuse 100 is plugged into one of the first and second fuse sockets 21 and 22 by inserting the fuse prongs 111 and 112 into corresponding slots of the fuse sockets 21 and 22. The first fuse prong 111 is a positive terminal and the second fuse prong 112 is a load terminal. The power plug 30 also includes a first power prong 311 and a second power prong 312. The first power prong 311 is a positive terminal and the second power prong 312 is a load terminal. The load cable 41 is connected to the third face and another load cable 42 is connected to another face opposite to the third face. Each of the load cables 41 and 42 electrically connects at least a car appliance, which may be an air conditioner 51, an event data recorder 52, a satellite navigation system 53, a cigarette lighter 54, a car stereo system 55, or a tire-pressure monitoring system 56 (as shown in FIG. 9).

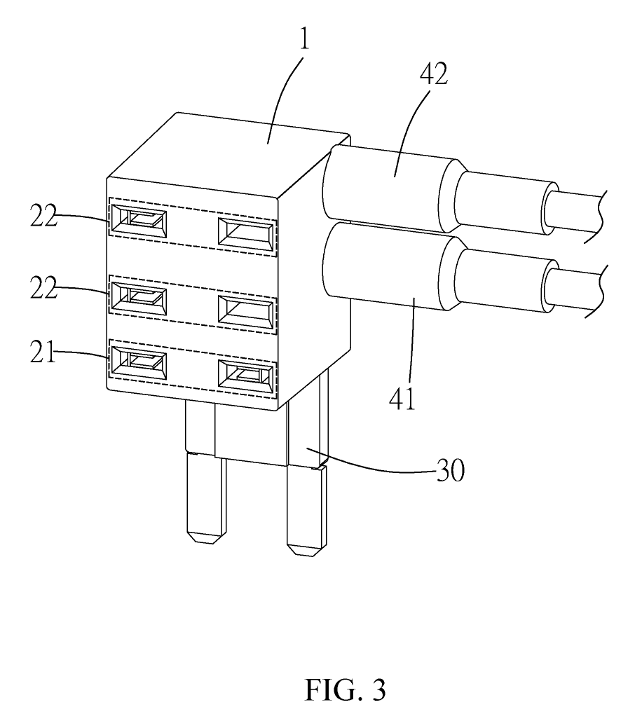

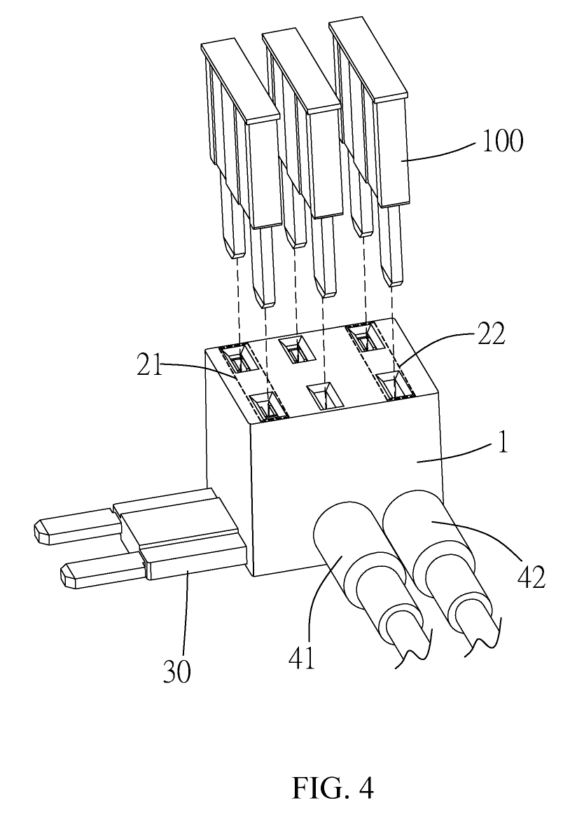

As shown in FIGS. 3 and 4, a second embodiment of the present invention differs from the previous embodiment in that the first and second fuse sockets 21 and 22 are now aligned and sequentially arranged, and that both the first and second load cables 41 and 42 are connected to the third face. As in the previous embodiment, each of the load cables 41 and 42 electrically connects at least a car appliance, which may be an air conditioner 51, an event data recorder 52, a satellite navigation system 53, a cigarette lighter 54, a car stereo system 55, or a tire-pressure monitoring system 56 (as shown in FIG. 9).

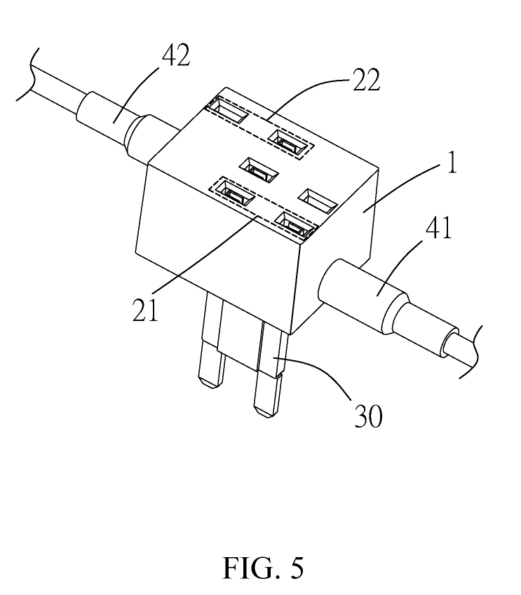

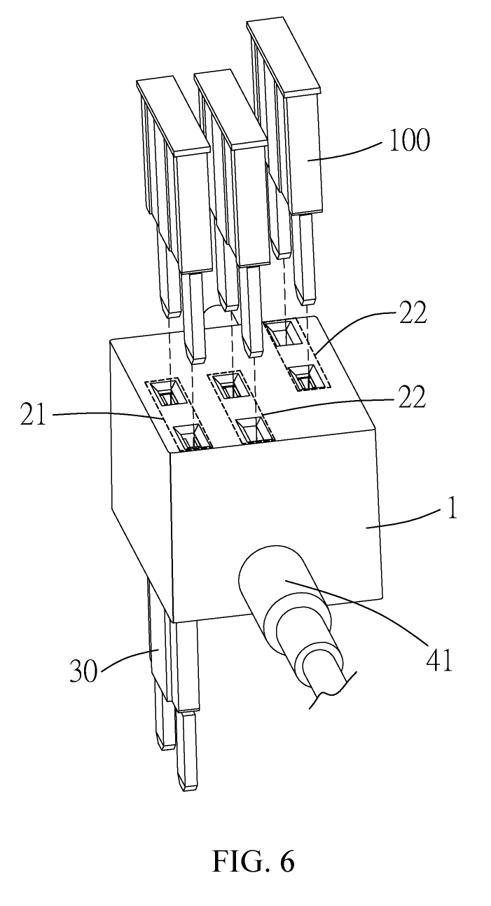

As shown in FIGS. 5 and 6, a third embodiment of the present invention differs from the previous embodiments in that the first and second faces are now parallel, not perpendicular, to each other. The power plug 30 still is extended perpendicularly from the second face, and the third face also borders on the first and second faces.

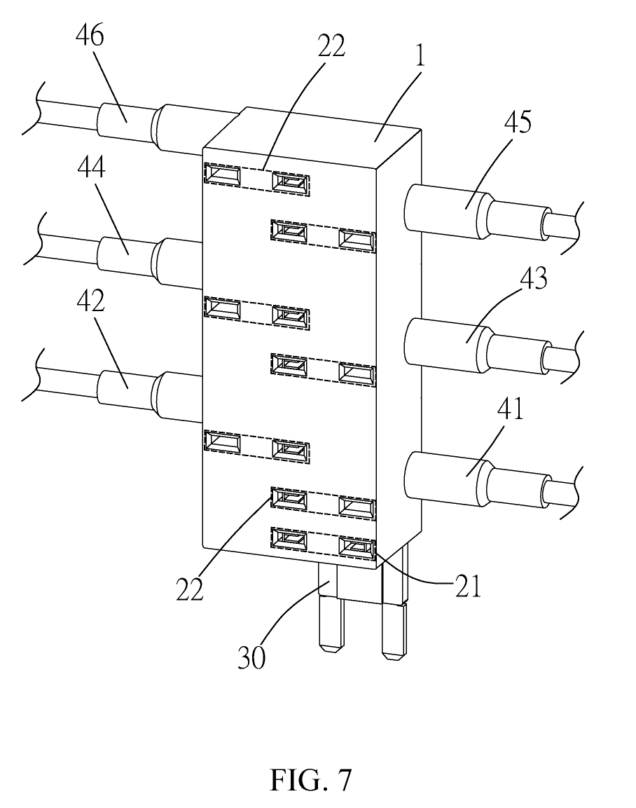

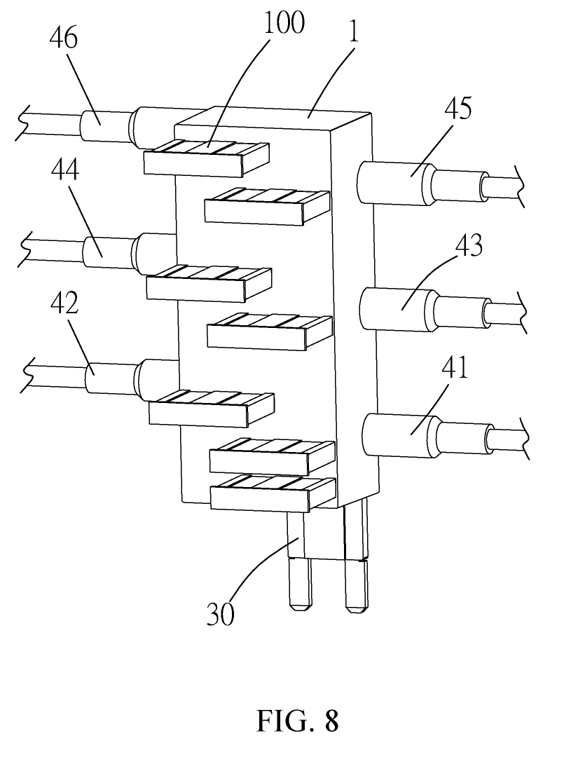

As shown in FIGS. 7 to 9, a fourth embodiment of the present invention differs from the previous embodiments in that, on the first face, there are now one first fuse socket 21 and multiple second fuse sockets 22. As shown in FIG. 7, each of the second fuse sockets 22 corresponds to one of the load cables 41, 42, 43, 44, 45, and 46. Then, in FIG. 8, the fuse sockets 21 and 22 are all installed with fuses 100. As shown in FIG. 9, the load cables 41 and 42 electrically and respectively connects an air conditioner 51, an event data recorder 52, a satellite navigation system 53, a cigarette lighter 54, a car stereo system 55, and a tire-pressure monitoring system 56. As such, these car appliances are all protected against overcurrent by the fuses 100 plugged into the second fuse sockets 22.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

1. A fuse box for at least two fuses, comprising:
a casing having a first face, a second face, and a third face;
a first fuse socket and a second fuse socket on the first face, where each first and second fuse socket comprises a first fuse slot and a second fuse slot;
a power plug on the second face, and electrically connected to the first fuse socket;
at least a load cable connected to the third face, where the load cable electrically connected to the second fuse socket, respectively;
wherein the first and second fuse sockets are for the detachable installation of the fuses; the power plug is protected by the fuse plugged into the first fuse socket; and the load cable is protected by the fuse plugged into the second fuse socket.

2. The fuse box according to claim 1, wherein the first and second faces are perpendicular to each other; the power plug is extended perpendicularly outward from the second face; and the third face borders on the first and second faces.

3. The fuse box according to claim 1, wherein the first and second faces are parallel to each other; the power plug is extended perpendicularly outward from the second face; and the third face borders on the first and second faces.

4. The fuse box according to claim 1, wherein each fuse comprises a first fuse prong and a second fuse prong.

5. The fuse box according to claim 4, wherein the first fuse prong is a positive terminal; and the second fuse prong is a negative terminal.

6. The fuse box according to claim 1, wherein the power plug comprises a first power prong and a second power prong.

7. The fuse box according to claim 6, wherein the first power prong is a positive terminal; and the second power prong is a negative terminal.

8. The fuse box according to claim 1, wherein the load cable electrically connects a car appliance.

9. The fuse box according to claim 8, wherein the car appliance is one of an air conditioner, an event data recorder, a satellite navigation system, a cigarette lighter, a car stereo system, and a tire-pressure monitoring system.
